(19) United States
(12) Patent Application Publication
(10) Pub. No.: US 2010/0301681 A1
(43) Pub. Date: Dec. 2, 2010

(54) Device for High-Voltage Direct-Current Transmission

(75) Inventors: Torsten Priebe, Erlangen (DE); Reinhard Wagner, Lauf (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Muenchen (DE)

(21) Appl. No.: 12/600,117

(22) PCT Filed: May 21, 2008
(86) PCT No.: PCT/EP2008/056245

§ 371 Date: Nov. 13, 2009

(30) Foreign Application Priority Data
May 25, 2007 (DE) 10 2007 024 976.6

(51) Int. Cl. G05F 3/02

(52) U.S. Cl. 307/151

(57) ABSTRACT

A device for high-voltage direct current transmission has a first converter unit and a second converter unit. The converter units are each connected to a main line and to a return line. Each converter unit is connected to a separate dedicated return line, and the return lines are connected to each other via a pole line. The pole line can be interrupted by a pole line interrupting unit. In this way, high variability in the operating modes is achieved, particularly for compensating for operational shut-offs.

The invention relates to a device for high-voltage direct-current transmission having a first converter unit and having a second converter unit which are in each case connected to a main line and to a return line.

Such a device is known from practical experience. In the previously known device, the converter units are in each case connected to a main line and to a common return line, the return line being connected to a single outgoing line of an auxiliary line arrangement in order to close the two direct-current circuits via a ground electrode which is the same for both main lines. However, this results in some restrictions in the operating modes of the device, especially when an operational disturbance occurs in the auxiliary line arrangement and a main line must therefore be used as return line.

The invention is based on the object of specifying a device of the type initially mentioned, which is distinguished by high variability in the operating modes, especially for compensating for operational shut-offs.

According to the invention, this object is achieved in a device of the type initially mentioned, in that each converter unit is connected to a separate independent return line and in that the return lines are connected to one another via a pole line which can be interrupted by a pole line interrupter unit.

Due to the fact that there are now two return lines which, in normal bipolar operation, are in each case allocated to one converter unit but are connected to one another via an interruptible pole line, a monopolar operation can however, still be maintained with the remaining conducting return line and the associated main line, for example in the case of operational shut-offs of a return line, when a pole line interrupter unit is then closed, or other operating modes can also be assumed.

Suitable further developments of the invention are the subject matter of the subclaims.

In the text which follows, an exemplary embodiment of a device according to the invention is explained in greater detail with reference to the figures of the drawing, in which:

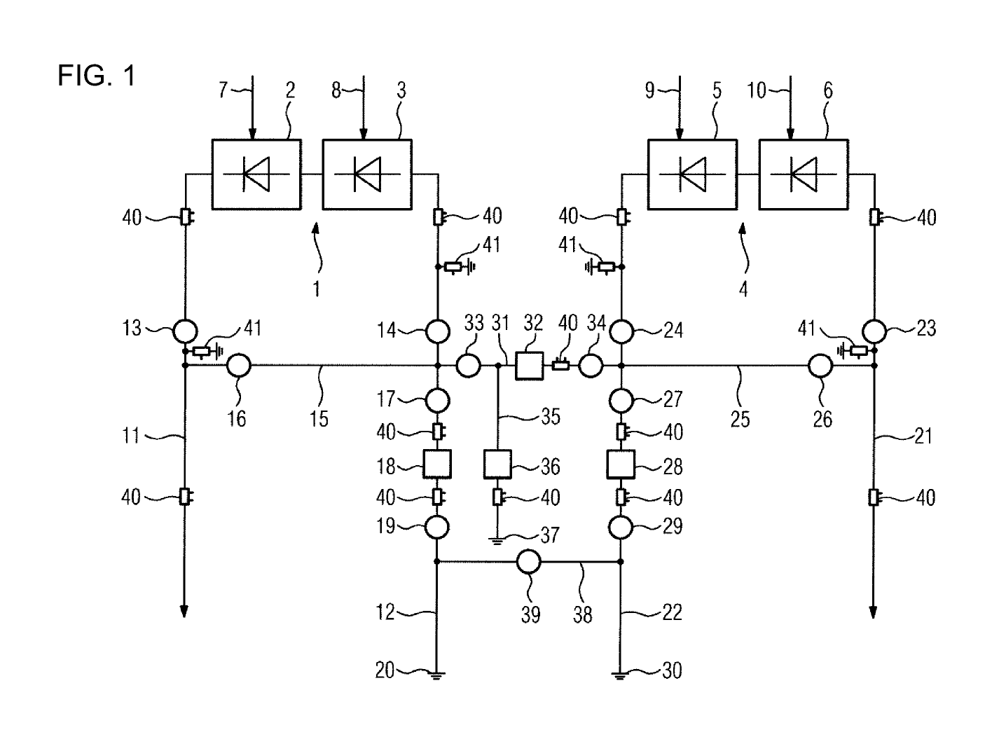

FIG. 1 shows in a circuit diagram an exemplary embodiment of a device according to the invention,

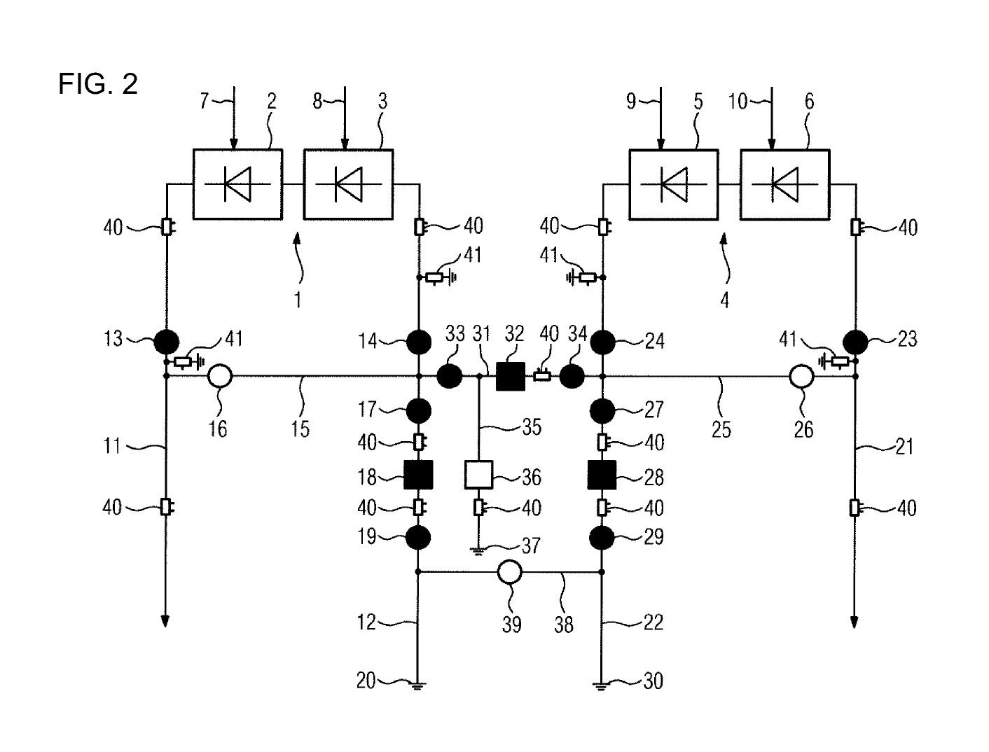

FIG. 2 shows the circuit diagram according to FIG. 1 in a bipolar operating mode of the device according to the invention with two return lines being in operation,

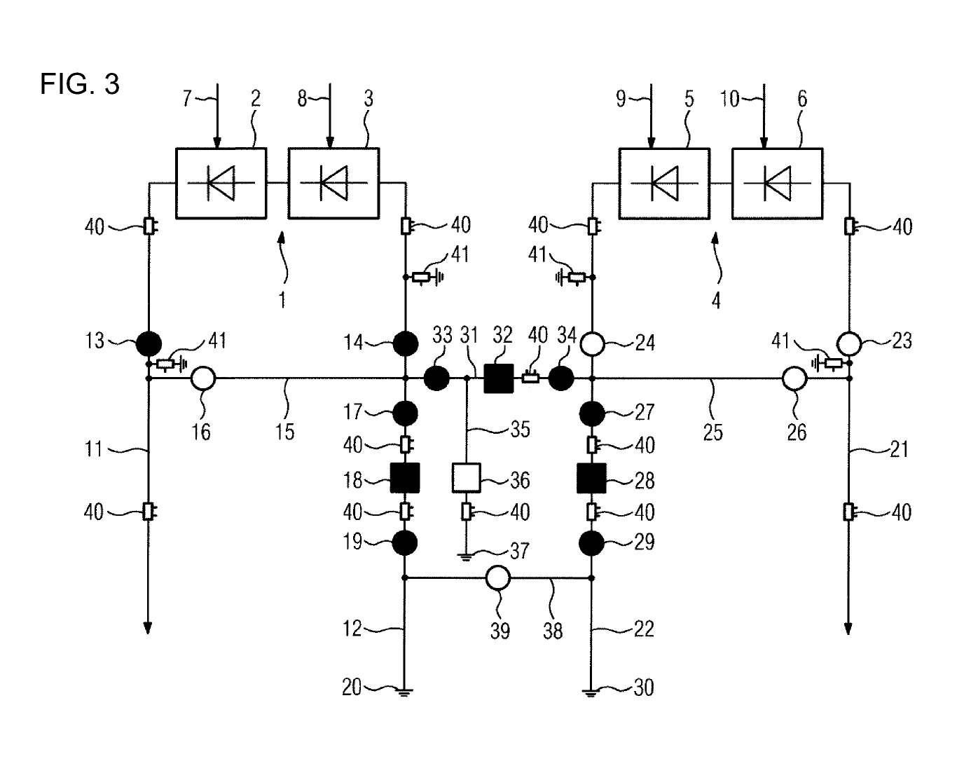

FIG. 3 shows the circuit diagram according to FIG. 1 in a monopolar operating mode of the device according to the invention with two return lines being in operation,

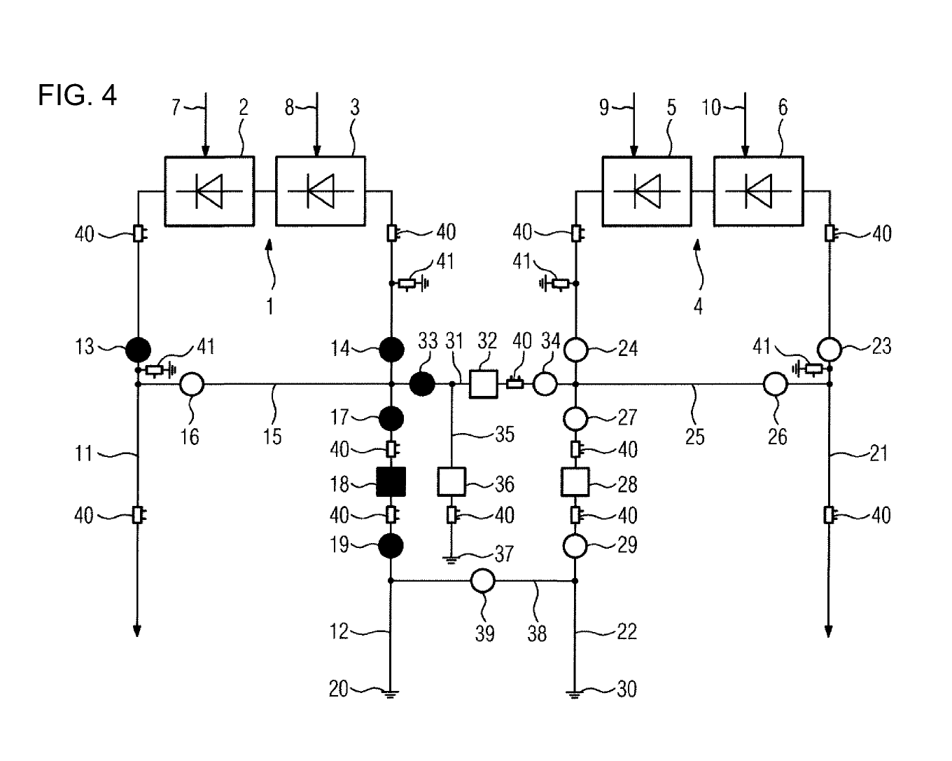

FIG. 4 shows the circuit diagram according to FIG. 1 in a monopolar operating mode of the device according to the invention with a single return line being in operation, and

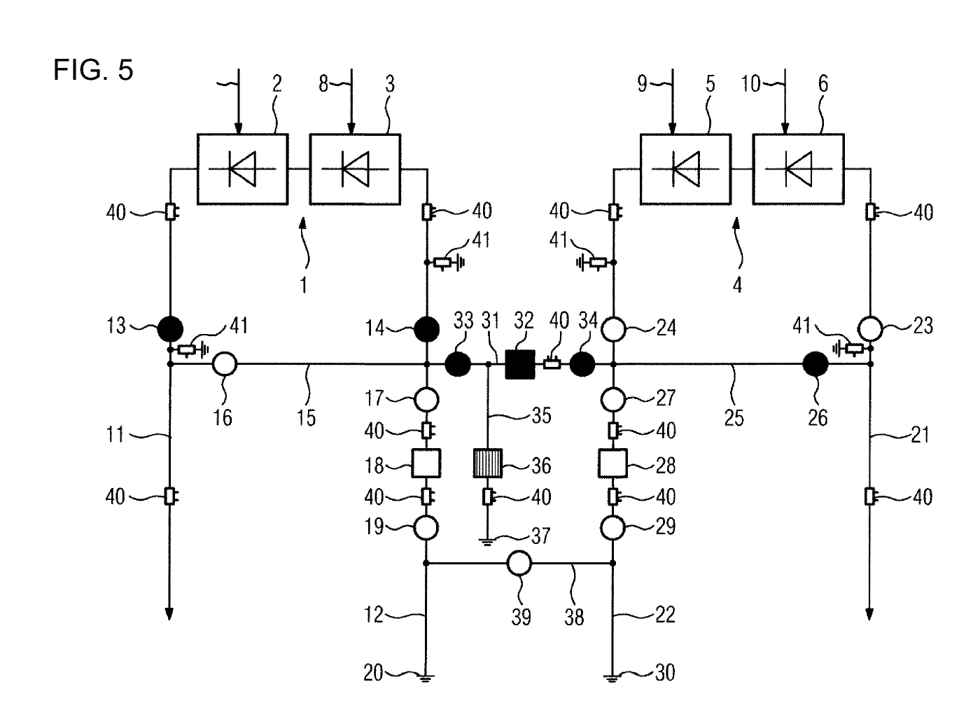

FIG. 5 shows the circuit diagram according to FIG. 1 in a monopolar operating mode of the device according to the invention with disconnected return lines and a second main line connected as return line for a first main line.

FIG. 1 shows in a circuit diagram an exemplary embodiment of a device according to the invention for bipolar high-voltage direct-current transmission. The device according to FIG. 1 has a first converter unit 1 which is represented here symbolically with two converters 2, 3, and a second converter unit 4 which is also represented here symbolically with two converters 5, 6. With each converter unit 1, 4, a direct voltage of the same order of magnitude in each case can be generated from an alternating voltage in the range of typically some 10 kilovolts to some 100 kilovolts fed into one of the relevant converter units 1, 4 via an alternating-voltage line arrangement 7, 8, 9, 10.

To the first converter unit 1, a first main line 11 and a first return line 12 are connected into which the direct voltage generated by the first converter unit 1 can be fed. Into the first main line 11, a main line isolating unit 13 is connected by means of which the first main line 11 can be interrupted in its outgoing line from the first converter unit 1 and, to clarify, it should be mentioned at this point that in the present description, the term “isolating unit” is understood to be a device for switching a currentless power line. Correspondingly, a first return line isolating unit 14, by means of which the first return line 12 can be interrupted in its outgoing line from the first converter unit 1, is connected into the first return line 12.

On the sides facing away from the first converter unit 1, of the main line isolating unit 13 placed into the first main line 11 and of the first return line isolating unit 14 placed into the first return line 12, a first jumper line 15 connects the first main line 11 and the first return line 12, a jumper line isolating unit 16, by means of which the first jumper line 15 can be interrupted, being connected into the jumper line 15.

On the side facing away from the first return line isolating unit 14 of the connection of the first jumper line 15 to the first return line 12, a second return line isolating unit 17, a return line interrupter unit 18 and a third return line isolating unit 19 are placed into the first return line 12 in a sequence with increasing distance from the first converter unit 1, and, to clarify, it should be mentioned at this point that in the present description, the term “interrupter unit” is understood to be a device for switching a current-conducting power line. The first return line 12 is grounded with its end leading away from the third return line isolating unit 19 to a grounding electrode 20.

Correspondingly, a second main line 21 and a second return line 22, into which the direct voltage generated by the second converter unit 4 can be fed, are connected to the second converter unit 4. Into the second main line 21, a main line isolating unit 23 is connected by means of which the second main line 21 can be interrupted in its outgoing line from the second converter unit 4. Correspondingly, a first return line isolating unit 24 by means of which the second return line 22 can be interrupted in its outgoing line from the second converter unit 4 is connected into the second return line 22.

On the side facing away from the second converter unit 4 of the main line isolating unit 23 placed into the second main line 21 and of the first return line isolating unit 24 placed into the second return line 22, a second jumper line 25 connects the second main line 21 and the second return line 22, a jumper line isolating unit 26 by means of which the second jumper line 25 can be interrupted being connected into the first jumper line 25.

On the side facing away from the first return line isolating unit 24 of the connection of the second jumper line 25 to the second return line 22, a second return line isolating unit 27, a return line interrupter unit 28 and a third return line isolating unit 29 are placed into the second return line 22 in a sequence increasing in distance from the second converter unit 4. The second return line 22 is grounded with its end facing away from the third return line isolating unit 29 to a grounding electrode 30.

Furthermore, FIG. 1 shows that a pole line 31 connecting the first return line 12 and the second return line 22 is placed between the first return line isolating units 14, 24 and the second return line isolating units 17, 27. Into the pole line 31, a pole line interrupter unit 32 is connected which can be voltagelessly switched on both sides by means of a first pole line isolating unit 33 and a second pole line isolating unit 34. Between the pole line interrupter unit 32 and a pole line isolating unit 33, 34 in the arrangement according to FIG. 1 of the first pole line isolating unit 33, a grounding line 35 is connected which connects the pole line 35 via a high-speed grounding unit 36 to an emergency grounding electrode 37 connected to ground.

Finally, a connecting line 38, which can be interrupted by means of a connecting line isolating unit 39 and can be closed in conductively switching manner for bypassing the connecting line 38, is placed between the return lines 12, 22 on the sides facing away from the return line interrupter units 18, 28 of the third return line isolating units 19, 29 for bypassing, if necessary, the sections of a return line 12, 22 between a second return line isolating unit 17, 27, a return line interrupter unit 18, 28 and a third return line isolating unit 19, 29.

For the sake of completeness, it should be mentioned that current measuring units 40 and voltage measuring units 41 are arranged in or respectively at various lines 11, 12, 21, 22, 31, 35 of the device shown in FIG. 1 at locations considered to be appropriate by the average expert.

In the text which follows, typical operating modes of the device according to the invention are explained, symbols filled out completely in black standing for a switched-through conductive state and symbols only edged in black and left white in the center standing for an opened nonconductive state in the isolating units and interrupter units.

FIG. 2 shows the circuit diagram according to FIG. 1 in a bipolar operating mode of the device according to the invention with all current-conducting operational main lines 11, 21 and with the two operational return lines 12, 22. In this operating mode, all isolating units 13, 14, 17, 19, 23, 24, 27, 29, 33, 34 and interrupter units 18, 28, 32 are switched to conduct apart from the jumper line isolating units 16, 26, the connecting line isolating unit 39 and the high-speed grounding unit 36 which, as a rule, is to be switched to conduct only in an emergency case, which are switched to be nonconducting. In this normal operating mode, the main lines 11, 22 are disconnected and the active return lines 12, 22 are connected to one another via the switched-through pole line 31. Both return lines can thus carry comparatively low compensating currents in comparison with the heavy currents at high voltage, flowing in the main lines 11, 22, at a typical total power of several 100 MW.

FIG. 3 shows the circuit diagram according to FIG. 1 in a monopolar operating mode of the device according to the invention with an operational main line 11, 21, in this case the first main line 11, and with two operational return lines 12, 22. In this operating mode, the jumper line isolating units 16, 26, the main line isolating unit 23 switching the second main line 21 to conduct, the first return line isolating unit 24 switching the second return line 22 to conduct, the high-speed grounding unit 36 and the connecting line isolating unit 39 are switched to be nonconducting whilst the remaining isolating units 13, 14, 17, 19, 27, 29, 33, 34 and interrupter units 18, 28, 32 are switched to conduct. The monopolar operating mode with the two operational return lines 12, 22 is assumed in the case of a shut-off of a main line 11, 21, in this case the second main line 21, in order to achieve a possible optimum discharge of the compensating currents also in this operating mode.

FIG. 4 shows the circuit diagram according to FIG. 1 in a monopolar operating mode of the device according to the invention with a single operational main line 11, 21, in this case the first main line 11, and a single operational return line 12, 22, in this case the first return line 12.

In this operating mode, the main line isolating unit 13 switching the first main line 11 to conduct, the isolating units 14, 17, 19 switching the first return line 12 to conduct, the return line interrupter unit 18 are switched to conduct and the first pole line interrupter unit 33 for rapidly switching through the high-speed grounding unit 36, if necessary, whilst the remaining isolating units 16, 23, 24, 26, 27, 29, 34, 39 and the remaining interrupter units 28, 32 including the high-speed grounding unit 36 are switched to be nonconducting. FIG. 4 shows that a monopolar operation can thus be maintained also in the case of the necessity of a shut-off of a return line 12, 22. Furthermore, FIG. 4 also shows that when a return line 12, 22 is shut off, a bipolar operating mode can also be maintained with current-carrying main lines 11, 21, in which mode the other return lines 12, 22 are switched to conduct for both main lines 11, 21.

FIG. 5 shows the circuit diagram according to FIG. 1 in a monopolar operating mode of the device according to the invention with a single operational main line 11, 21, in this case the first main line 11, and with a disconnected return line 12, 22, the second main line 21 being switched as return line for the first main line 11 and the grounding line 35 being switched as auxiliary line for grounding the compensating currents. In this operating mode, the main line isolating unit 13 switching the first main line 11 to conduct, the first return line isolating unit 14 switching the first return line 12 to conduct up to the second return line isolating unit 17, the pole line isolating unit 33, 34 and the jumper line isolating units 26 switching the second jumper line 25 to conduct are switched to conduct whilst the remaining isolating units 16, 17, 19, 23, 24, 27, 29, 39 and the return line interrupter units 18, 28 are switched to be nonconducting. In this operating mode, the high-speed grounding unit 36 is switched to conduct for the first converter unit 1 for safety reasons.

Furthermore, it can be seen by the average expert when looking at the above statements in combination that, due to the arrangement of the isolating units 13, 14, 16, 17, 19, 23, 24, 27, 29, 33, 34, 39, selective certain operating areas of the device according to the invention can be switched to be voltageless in order to perform maintenance work. In this connection, it is particularly appropriate that the arrangement shown in FIG. 1 is free of intersections of lines 11, 12, 15, 21, 22, 25, 31, 38 which potentially carry high voltage, which considerably reduces the risk of critical situations especially during maintenance work.

1-6. (canceled)

7. A device for high-voltage direct-current transmission, comprising:
a first converter unit connected to a main line and to a first return line;
a second converter unit connected to a main line and to a second return line separate from said first return line;
a pole line connecting said first return line with said second return line; and
a pole line interrupter unit disposed to enable said pole line to be interrupted.

8. The device according to claim 7, which comprises a grounding line connected to said pole line, and a high-speed grounding unit connected in said grounding line for rapidly connecting said pole line to an emergency grounding electrode connectible to said pole line via said grounding line.

9. The device according to claim 8, which comprises at least one pole line isolating unit respectively placed on both sides of a node connecting said grounding line and said pole line interrupter unit to said pole line.

10. The device according to claim 7, which comprises a jumper line connected between said main line connected to said first converter unit and said first return line and a jumper line connected between said main line connected to said second converter unit and said second return line, and a jumper line isolating unit respectively connected into each said jumper line for interrupting each said jumper line.

11. The device according to claim 7, which comprises a return line interrupter unit connected in each said return line between a connection of said pole line and a connection of a connecting line connected between said return lines, wherein each said return line interrupter unit is decouplable via return line isolating units arranged on both sides thereof.

12. The device according to claim 11, which comprises a connecting line isolating unit connected in said connecting line for interrupting said connecting line, and wherein said connecting line is connected to said return lines on a side of said return line isolating units distally from said converter units.
